(19) United States
(12) Patent Application Publication
(10) Pub. No.: US 2025/0023089 A1
(43) Pub. Date: Jan. 16, 2025

(54) LAMINATED BATTERY AND METHOD OF MANUFACTURING LAMINATED BATTERY

(71) Applicant: TOYOTA JIDOSHA KABUSHIKI KAISHA, Toyota-shi (JP)

(72) Inventors: Masashi CHIHARA, Nagoya-shi (JP); Kenichi Kakishita, Nagoya-shi (JP); Sumiko Kito, Nagoya-shi (JP)

(73) Assignee: TOYOTA JIDOSHA KABUSHIKI KAISHA, Toyota-shi (JP)

(21) Appl. No.: 18/679,529

(22) Filed: May 31, 2024

(30) Foreign Application Priority Data
Jul. 13, 2023 (JP) 2023-115430

(51) Int. Cl. H01M 10/04; H01M 50/124

(52) U.S. Cl. CPC H01M 10/0431; H01M 10/0481; H01M 50/1243

(57) ABSTRACT

The laminated battery includes an electrode body and a laminate film enclosing the electrode body. The laminate film has a structure in which a metal layer and a fusion resin layer are at least laminated on the inside of the metal layer. The laminate film has a fused portion in which the fusion resin layers of the inner surface are fused by overlapping end portions, a portion of the fused portion, the metal layers to each other has a metal adhesion portion that is in close contact over the entire area in the longitudinal direction of the fused portion.

### CROSS-REFERENCE TO RELATED APPLICATION

This application claims priority to Japanese Patent Application No. 2023-115430 filed on Jul. 13, 2023, incorporated herein by reference in its entirety.

### BACKGROUND

### 1. Technical Field

The present disclosure relates to a laminated battery and a method of manufacturing a laminated battery.

### 2. Description of Related Art

In a laminated battery in which an electrode body is covered by laminate films, a part of the laminate films is fused to form a fused portion in order to seal the electrode body.

For example, Japanese Unexamined Patent Application Publication No. 2019-200973 (JP 2019-200973 A) discloses a method of manufacturing a secondary battery in which a folded portion is provided at least one end portion of a laminated exterior body. This manufacturing method includes bringing a holding plate into contact with a base point of folding of an end portion of an exterior body and forming a folded portion. The folded portion is formed, after bringing the holding plate into contact with the base point, by sliding the holding plate and a pressing plate disposed at a position facing the holding plate so as to sandwich the end portion to fold the end portion around the base point, and sandwiching the end portion using the holding plate and the pressing plate. Surfaces of the pressing plate that slide with the end portion include an inclined surface that folds the end portion and a clamping surface that clamps the end portion. The inclined surface is inclined such that the sectional area of the pressing plate narrows in the sliding direction in a section orthogonal to the width direction of the pressing plate. The inclined surface is inclined in the width direction.

### SUMMARY

In the conventional laminated battery, the end portions of the laminate films, each including at least a metal layer and a fusion resin layer, are superposed to form a fused portion in which fusion resin layers on the inner surfaces are fused to each other. However, moisture may enter the electrode body through the fusion resin layers in the fused portion, and the battery performance may deteriorate.

The present disclosure has been made in view of the above circumstances, and has an object to provide a laminated battery in which deterioration in battery performance due to intrusion of moisture into an electrode body is suppressed, and a method of manufacturing the laminated battery.

<1>

A laminated battery including:
an electrode body; and
laminate films that cover and seal the electrode body, in which:
the laminate films each have a structure including at least a metal layer and a fusion resin layer stacked on an inner side of the metal layer;
the laminate films include a fused portion in which respective end portions of the laminate films are superposed to fuse the fusion resin layers on inner surfaces of the laminate films; and
a metal adhesion portion in which the metal layers closely contact each other over the entire fused portion in a longitudinal direction of the fused portion is provided in a part of the fused portion.

<2> The laminated battery according to <1>, in which
the fused portion includes a bent portion bent in an angular shape or an arcuate shape, and
the metal adhesion portion is disposed in a region other than the bent portion.

<3> The laminated battery according to <1> or <2>, in which
the fused portion includes a plurality of metal adhesion portions.

<4> A method of manufacturing a laminated battery including an electrode body and laminate films that cover and seal the electrode body, the laminate films each having a structure including at least a metal layer and a fusion resin layer stacked on an inner side of the metal layer, and the laminate films including a fused portion in which respective end portions of the laminate films are superposed to fuse the fusion resin layers on inner surfaces of the laminate films, the method including
pressing the fused portion by sandwiching the fused portion from both sides using a pressing member and an opposing member, and forming a metal adhesion portion in which the metal layers closely contact each other over the entire fused portion in a longitudinal direction of the fused portion, in which
in the pressing, at least one of the pressing member and the opposing member is heated to a temperature equal to or higher than a glass transition temperature of the fusion resin layer.

<5> The method according to <4>, in which:
a tip of the pressing member to contact the fused portion has a curved shape with a radius of curvature R of 0.2 mm or more and 1.68 mm or less; and
a tip of the opposing member to contact the fused portion has a smooth flat shape.

According to the present disclosure, it is possible to provide a laminated battery in which deterioration in battery performance due to intrusion of moisture into an electrode body is suppressed and a method of manufacturing the laminated battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a laminated battery according to an embodiment of the present disclosure;

FIG. 2 is a schematic cross-sectional view illustrating a laminated battery having a bent portion in a fused portion according to an embodiment of the present disclosure;

FIG. 3 is a schematic cross-sectional view illustrating one step in a method of manufacturing a laminated battery according to an embodiment of the present disclosure; and

FIG. 4 is a schematic cross-sectional view illustrating a pressing process using a pressing roll having a curved tip and an opposing roll having a smooth tip in the method of manufacturing a laminated battery according to the embodiment of the present disclosure.

### DETAILED DESCRIPTION OF EMBODIMENTS

### Laminated Battery

A laminated battery according to an embodiment of the present disclosure includes an electrode body and a laminate film encapsulating the electrode body. The laminate film has a structure in which at least a metal layer and a fusion resin layer are laminated on the inner side of the metal layer, and the laminate film has a fused portion in which end portions of the laminate film are superposed to fuse the fusion resin layers on the inner surface. Then, a portion of the fused portion, the metal layer to each other has a metal adhesion portion that is in close contact over the entire area in the longitudinal direction of the fused portion.

Hereinafter, an embodiment of a laminated battery according to the present disclosure will be described with reference to the drawings.

Each drawing shown below is schematically shown, and the size and shape of each part are appropriately exaggerated for easy understanding.

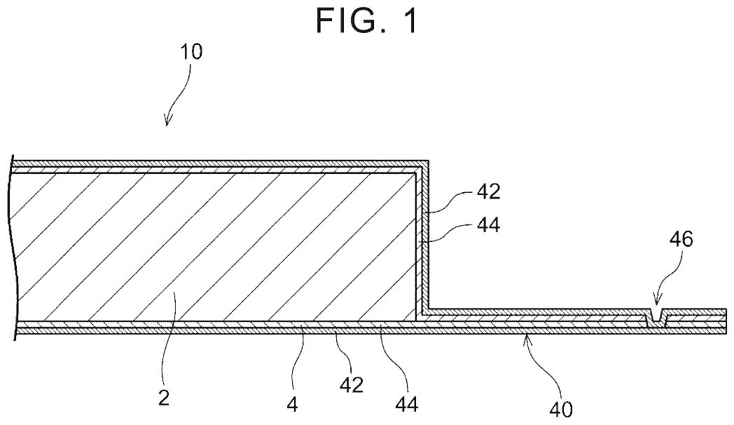

FIG. 1 is a schematic cross-sectional view illustrating a laminated battery according to an embodiment of the present disclosure.

The laminated battery 10 illustrated in FIG. 1 includes an electrode body 2 and a laminate film 4 that covers and encloses the electrode body 2. The laminate film 4 has a structure in which at least a metal layer 42 and a fusion resin layer 44 are laminated on the inside of the metal layer 42. The laminate film 4 may further have a structure including a protective resin layer on the outside of the metal layer 42. The laminate film 4 has a fused portion 40 in which end portions are superposed to each other and the fusion resin layers 44 on the inner surface are fused to each other. A metal adhesion portion 46 in which the metal layers 42 are in close contact with each other is provided in a part of the fused portion 40. In the metal adhesion portion 46, the metal layers 42 are in direct contact with each other without interposing the fusion resin layer 44. In addition, in the metal adhesion portion 46, the metal layers 42 are in close contact with each other over the entire area of the fused portion 40 in the longitudinal direction (depth direction in FIG. 1).

In the conventional laminated battery, the end portions of the laminate film having at least the metal layer and the fusion resin layer are superposed on each other to form a fused portion in which the fusion resin layers on the inner surface are fused to each other. However, moisture may enter the electrode body through the fusion resin layer in the fused portion, and the battery performance may deteriorate.

On the other hand, the laminated battery 10 according to the present embodiment has a metal adhesion portion 46 in which the metal layers 42 are in close contact with each other over the entire area in the longitudinal direction of the fused portion 40, in a part of the fused portion 40. Therefore, intrusion of moisture through the fusion resin layer of the fused portion is suppressed by the metal adhesion portion 46, and as a result, deterioration in battery performance can be suppressed.

### Number of Metal Contact Portions

The fused portion of the laminate film preferably has a plurality (i.e., two or more) of metal adhesion portions. Each of the plurality of metal adhesion portions is such that the metal layers are in close contact with each other over the entire area in the longitudinal direction of the fused portion. By having a plurality of metal contact portions, deterioration in battery performance due to intrusion of moisture into the electrode body can be further suppressed.

### Position of the Metal Contact Portion

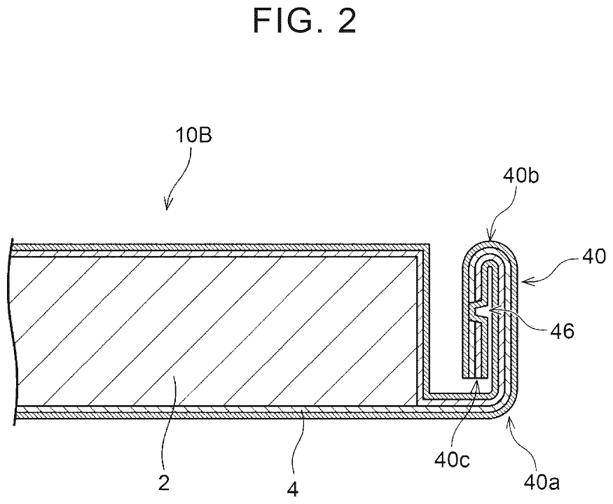

The laminated battery according to the embodiment of the present disclosure may have a bent portion bent in a corner shape or an arc shape in the fused portion. By having the bent portion, the structural efficiency of the laminated battery can be increased. Here, an example of a laminated battery having a bent portion in the fused portion is shown in FIG. 2. The laminated battery 10B has a bent portion 40a and a 40b bent in a square shape or an arc shape in the fused portion 40 of the laminate film 4. The bent portion 40a is bent so as to have an angle of approximately 90°, and the bent portion 40b is bent so as to have an angle of approximately 0°.

In a case where a bent portion is formed in the fused portion, the metal adhesion portion is preferably disposed in a region other than the bent portion. By disposing the metal contact portion in a region other than the bent portion, the bent portion can be formed into a good shape.

For example, in the laminated battery 10B of the embodiment shown in FIG. 2, the metal adhesion portion 46 is disposed between the bent portion 40b and the tip 40c of the fused portion 40, and is disposed in an area other than the bent portion. In the case of owning two bent portions in the bonding portion as in the embodiment shown in FIG. 2, it is preferred that the metal contact portion is located between (i) the root of the fused portion (i.e., the end of the side of the electrode body 2 in the fused portion 40 in FIG. 2) and the first bent portion (the bent portion 40a in FIG. 2), (ii) from the root side, the first bent portion (the bent portion 40a in FIG. 2) and the second bent portion (the bent portion 40b in FIG. 2), or (iii) from the root side, the second bent portion (the bent portion 40b in FIG. 2) and the front end of the fused portion (the tip 40c in FIG. 2).

However, from the viewpoint of securing the fusion strength of the fused portion, it is preferable to dispose the metal adhesion portion at a position closer to the tip of the fused portion (the tip 40c in FIG. 2). For example, if it has two bent portions in the fused portion, it is preferable to dispose the metal adhesion portion between the second bent portion from the root (bent portion 40b in FIG. 2) to the tip of the fused portion (the tip 40c in FIG. 2).

On the other hand, if it is possible to secure the fusion strength of the fused portion, it is preferable to dispose the metal adhesion portion at a position closer to the root of the fused portion (the end portion on the electrode body 2 side in the fused portion 40 in FIG. 2). For example, if there are two bent portions in the fused portion, (i) between the root of the fused portion (end portion of the electrode body 2 side in the fused portion 40 in FIG. 2) to the first bent portion (bent portion 40a in FIG. 2), or (ii) between the first bent portion from the root side (bent portion 40a in FIG. 2) to the second bent portion (bent portion 40b in FIG. 2), it is preferable to arrange the metal adhesion portion. By disposing the metal adhesion portion closer to the root of the fused portion, it is possible to further suppress the intrusion of moisture from the side surface of the fused portion (the side surface of the fused portion 40 on the depth side and the near side in FIG. 2). Further, after disposing the metal adhesion portion closer to the root of the fused portion, the length of the fused portion may be shortened (that is, the trimming position on the distal end side of the fused portion may be closer to the root side of the fused portion).

### Method of Manufacturing Laminated Battery

Next, a method of manufacturing a laminated battery according to an embodiment of the present disclosure will be described.

A laminated battery according to an embodiment of the present disclosure includes an electrode body and a laminate film encapsulating the electrode body. The laminate film has a structure in which a metal layer and a fusion resin layer are at least laminated on the inside of the metal layer. The laminate film has a fused portion in which end portions are overlapped and fusion resin layers on the inner surface are fused to each other.

Then, a method of manufacturing a laminated battery includes a pressing step of pressing the fused portion by sandwiching the pressing member and the opposing member from both sides of the fused portion, and forming a metal adhesion portion in which the metal layers are in close contact with each other over the entire area in the longitudinal direction of the fused portion. In this pressing step, at least one (preferably both) of the pressing member and the opposing member is heated to a temperature equal to or higher than the glass transition temperature of the fusion resin layer.

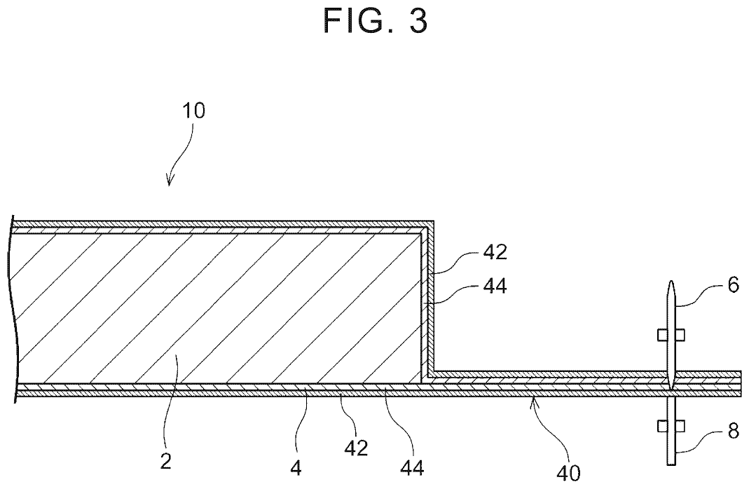

An embodiment of a method of manufacturing a laminated battery according to the present disclosure will now be described with reference to the drawings. FIG. 3 is a schematic cross-sectional view illustrating one step in a method of manufacturing a laminated battery according to an embodiment of the present disclosure. The laminated battery shown in FIG. 1 can be obtained by the method of manufacturing the laminated battery shown in FIG. 3.

The laminated battery 10 illustrated in FIG. 3 includes an electrode body 2 and a laminate film 4 that covers and encloses the electrode body 2. The laminate film 4 has a structure in which at least a metal layer 42 and a fusion resin layer 44 are laminated on the inside of the metal layer 42. The laminate film 4 has a fused portion 40 in which end portions are superposed to each other and the fusion resin layers 44 on the inner surface are fused to each other.

A method of manufacturing a laminated battery includes a pressing step of sandwiching the laminated battery 10 from both sides of the fused portion 40 (in FIG. 3, the vertical direction) by a pressing roll 6 as a pressing member and an opposing roll 8 as an opposing member, and pressing the fused portion 40. In the pressing step shown in FIG. 3, the fused portion 40 of the laminate film 4 of the laminated battery 10 is passed between the pressing roll 6 and the opposing roll 8 that rotate in the forward direction with respect to each other (that is, the rotation direction of each other is the reverse direction), whereby the fused portion 40 is pressed by the pressing roll 6 and the opposing roll 8. At least one (preferably both) of the pressing roll 6 which is the pressing member and the opposing roll 8 which is the opposing member is heated to a temperature equal to or higher than the glass transition temperature of the resin constituting the fusion resin layer 44. By this pressing step, the resin constituting the fusion resin layer 44 of the fused portion 40 is melted, the resin having increased fluidity is pushed away by the pressure from the pressing roll 6 and the opposing roll 8, the metal layers 42 are in direct contact with each other. As a result, the metal adhesion portion in which the metal layers 42 are in close contact with each other is formed over the entire area in the longitudinal direction (depth direction in FIG. 3) of the fused portion 40.

Incidentally, the direction of pressing the pressing member (e.g., pressing roll) and the opposing member (e.g., opposing roll) to the fused portion of the laminate film, the reverse direction to FIG. 3, that is, pressing the pressing member from the lower side in FIG. 3, the opposing member may be pressed from the upper side.

### Press Temperature

At least one (preferably both) of the pressing member and the opposing member in the pressing step is heated to a temperature equal to or higher than the glass transition temperature of the resin constituting the fusion resin layer. The heating temperature is preferably equal to or lower than the melting point of a material (for example, a material constituting a metal layer, a protective resin layer, or the like) constituting a layer other than the fusion-bonded resin layer in the laminate film. The heating temperature in the pressing step is preferably, for example, 120° C. or more and 220° C. or less, and more preferably 160° C. or more and 220° C. or less from the viewpoint of instantaneously melting the resin constituting the fusion resin layer.

### Clearance

The clearance between the pressing member and the opposing member in the pressing step (the shortest distance at a position where the pressing member and the opposing member face each other) is preferably equal to or greater than the total thickness of the metal layer in the laminate film constituting the fused portion. The total thickness of the metal layer is twice the thickness of the metal layer in a case where the thicknesses of the metal layers are equal to each other in the laminate films superposed in the fused portion. When the clearance is equal to or larger than the total thickness of the metal layer in the fused portion, a decrease in the thickness of the metal layer can be suppressed.

In the case where the laminate film further has a protective resin layer on the outside of the metal layer 42, the clearance between the pressing member and the opposing member is preferably equal to or less than the total thickness of the metal layer and the protective resin layer in the laminate film constituting the fused portion. The total thickness of the metal layer and the protective resin layer is twice the sum of the thickness of the metal layer and the thickness of the protective resin layer when the thicknesses of the metal layer and the protective resin layer are equal to each other in the laminate films superposed in the fused portion. When the clearance is equal to or less than the total thickness of the metal layer and the protective resin layer in the fused portion, it is possible to satisfactorily press the fused portion. As a result, the metal adhesion portion can be formed satisfactorily.

Here, the thickness of the metal layer and the thickness of the protective resin layer represent the average thickness of one metal layer and the average thickness of one protective resin layer at the place where the laminate film is pressed. As the average thickness, five positions are arbitrarily selected from the positions where the laminate film is pressed, the thickness of the metal layer or the protective resin layer is measured, and the arithmetic average value of the respective thicknesses at the five positions is used. In addition, the total thickness of the metal layer represents the sum of the average thickness of the metal layer in one laminate film and the average thickness of the metal layer in the other laminate film at the place where pressing is performed on the fused portion in which the end portions are superposed. The total thickness of the metal layer and the protective resin layer represents the sum of the average thickness of the metal layer and the average thickness of the protective resin layer in one laminate film and the average thickness of the metal layer and the average thickness of the protective resin layer in the other laminate film at the place where the fused portion is pressed.

### Shape of the Tip of the Pressing Member and the Opposing Member

It is preferable that a shape of a tip of the opposing member (for example, the opposing roll) in contact with the fused portion is a smooth shape or a V-shaped shape. When the distal end of the opposing member is smooth, the amount of deformation of the laminate film at the metal adhesion portion is suppressed. As a result, it is possible to suppress the influence on the bendability at the time of forming the bent portion in the fused portion of the laminate film. When the tip end of the opposing member is V-shaped, the adhesion between the metal layers in the metal adhesion portion can be further enhanced. The shape of the distal end of the opposing member is more preferably smooth from the viewpoint of the influence on the bendability when the bent portion is formed in the fused portion.

On the other hand, the shape of the tip of the pressing member (for example, the pressing roll) in contact with the fused portion is preferably curved from the viewpoint of suppressing the breakage of the metal layer (or the protective resin layer in the case of having a protective resin layer) in the laminate film.

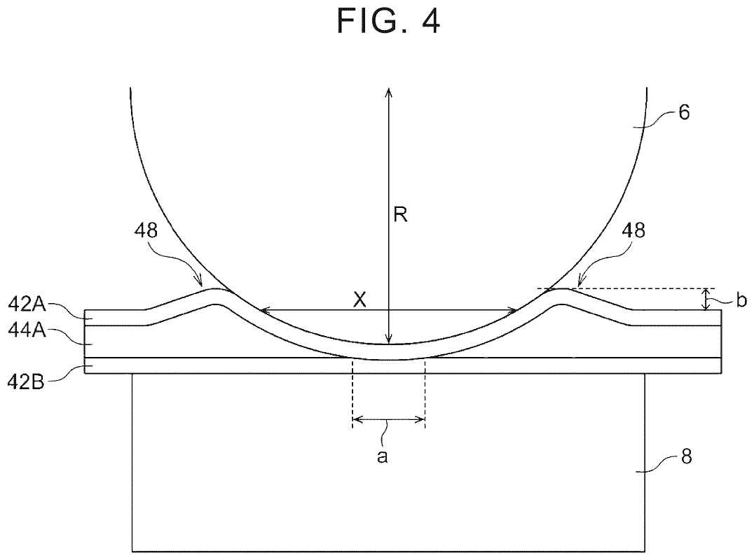

FIG. 4 is a diagram illustrating a pressing process using a pressing roll having a curved tip and an opposing roll having a smooth tip. In FIG. 4, the metal layer 42A and 42B, and the fusion resin 44A in which the fusion resin layers are fused and fused together, with respect to the fused portion, the pressing roll 6 from above in FIG. 4, by pressing the opposing roll 8 from below, to form a metal adhesion portion. Note that the resin of the fusion resin 44A is melted by the heat and pressure from the pressing roll 6 and the opposing roll 8, and is pushed away to the distal end side and the root side of the fused portion (the left-right direction in FIG. 4). Therefore, the raised portion 48 is formed around the metal adhesion portion by the displaced resin.
Therefore, in a pressing member (for example, a pressing roll) having a curved tip, the radius of curvature R of the tip is preferably 1.68 mm or less. When the radius of curvature R of the tip is within this range, the amount of the fused resin to be displaced does not become too large, and the raised portion (the raised portion 48 in FIG. 4) formed around the metal adhesion portion does not become too large. As a result, it is possible to suppress the influence on the bendability at the time of forming the bent portion in the fused portion of the laminate film.

Incidentally, the reason why the radius of curvature R of the tip of the pressing member having a curved tip is preferable to be 1.68 mm or less will be described with reference to FIG. 4.

A condition under which an influence on the bendability at the time of forming the bent portion in the fused portion of the laminate film can be suppressed is assumed as in the following formula (1). Note that X in Expression (1) represents the length X at the height of the front face of the metal-layer 42A prior to the pressing at the position recessed by the pressing in the pressing roll 6.

$$X \leq {L}_{1} / 2 \qquad Expression ( 1 )$$

Here, the L₁ represents the distance from the tip of the fused portion of the laminate film to the position where the bent portion is formed.
The value of X is represented by the following formula (2).

$$X = 2 √ ( {R}^{2} - {( R - 2 {t}_{3} )}^{2} ) \qquad Expression ( 2 )$$

Here, R represents the radius of curvature of the distal end of the pressing member, and t₃ represents the mean thickness of one metallic layer at the place where the laminate film is pressed. Here, “√( )” represents “( )^{1/2}”.
The following equation (3) is derived from equations (1) and (2).

$$R \leq ( {L}_{1}^{2} ) / ( 64 {t}_{3} ) - {t}_{3} \qquad Expression ( 3 )$$

Further, when a typical L₁=3 mm, and t₃=0.08 mm are applied for L₁ and t₃, Equation (4) below is derived.

$$R \leq 1.68 \qquad Expression ( 4 )$$

From the above, from the viewpoint of suppressing the influence on the bendability when forming the bent portion in the fused portion of the laminate film, the radius of curvature R of the tip of the pressing member (e.g., the pressing roll) having a curved tip is preferably 1.68 mm or less.

On the other hand, the lower limit of the radius of curvature R of the tip in the pressing member (e.g. pressing roll) having a curved tip is preferably 0.2 mm or more, from the viewpoint of suppressing the breakage of the metal layer in the laminate film (further protective resin layer in the case of having a protective resin layer).

From the above, the radius of curvature R of the tip of the pressing member is preferably 0.2 mm or higher and 1.68 mm or less.

The length of the region in which the metal layers are in close contact with each other in the metal adhesion portion (the length in the direction orthogonal to the longitudinal direction and the thickness direction of the fused portion (the length a in the left-right direction in FIG. 4)) is preferably 50 μm or more and 300 μm or less, and more preferably 80 μm or more and 200 μm or less.

When the length of the region in which the metal layers are in close contact with each other is equal to or less than the upper limit value, the amount of the fused resin to be displaced does not become too large. Therefore, it is possible to suppress the influence on the bendability at the time of forming the bent portion in the fused portion of the laminate film. When the length of the region in which the metal layers are in close contact with each other is equal to or greater than the lower limit value, the intrusion of moisture into the electrode body can be suppressed more favorably.

The height of the raised portion (the raised portion 48 in FIG. 4) formed around the metal adhesion portion is preferably 150 μm or less, and more preferably 100 μm or less. The lower the height of the raised portion, the more preferable.

When the height of the raised portion is equal to or less than the above upper limit value, it is possible to suppress the influence on the bendability at the time of forming the bent portion in the fused portion of the laminate film.
The height of the raised portion represents the mean value of the distance (height b in FIG. 4) from the surface of the metal layer (the surface of the metal layer 42A in FIG. 4) to the apex of the raised portion at the place where the metal adhesion portion and the raised portion are not formed. As the average value of the heights of the raised portions, five portions where the raised portions are formed are selected, the height of the raised portions is measured, and the arithmetic average value of the heights at the five portions is used.

### Battery Member

Next, an electrode body and a laminate film constituting the laminated battery according to the present embodiment will be described.

### (1) Laminate Film

The laminate film has at least a metal layer and a protective resin layer on the outside of the metal layer. The laminate film may be a film having a three-layer structure further having a fusion-bonded resin layer on the inner side of the metal layer.

Examples of the adhesive resin include olefinic resins such as polypropylene (PP) and polyethylene (PE). Examples of the material of the metal layer include aluminum, aluminum alloy, and stainless steel. Examples of the material of the protective resin layer include polyethylene terephthalate (PET) and nylon. The thickness of the fusion resin layer is, for example, 40 μm or more and 100 μm or less. The thickness of the metal layer is, for example, 30 μm or more and 60 μm or less. The thickness of the protective resin layer is, for example, 20 μm or more and 60 μm or less. The thickness of the entire laminate film is, for example, 70 μm or more and 220 μm or less.

### (2) Electrode Body

The electrode body functions as a power generation element of the battery. The electrode body generally includes a positive electrode current collector, a positive electrode active material layer, an electrolyte layer, a negative electrode active material layer, and a negative electrode current collector in this order in the thickness direction.

The positive electrode active material layer contains at least a positive electrode active material. The positive electrode active material layer may further contain at least one of a conductive material, an electrolyte and a binder. The shape of the positive electrode active material is, for example, particulate. Examples of the positive electrode active material include an oxide active material. Further, sulfur(S) may be used as the positive electrode active material.

The positive electrode active material preferably contains a lithium composite oxide. The lithium composite oxide may contain at least one selected from the group consisting of F, CI, N, S, Br, and I. The lithium composite oxide may have a crystal structure belonging to at least one space group selected from the space group R-3m, Immm, and P63-mmc (also referred to as P63mc, P6/mmc). In addition, the lithium composite oxide may have a structure in which the main arrangement of the transition-metal, the oxygen, and the lithium is O2.

Examples of the lithium composite oxide having a crystal structure belonging to R-3m include a compound represented by LiₓMe_{y}O_{α}X_{β}. Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P. X represents at least one selected from the group consisting of F, Cl, N, S, Br, and I. 0.5≤x≤1.5, 0.5≤y≤1.0, 1≤α<2, 0<β≤1 are satisfied.

Examples of the lithium composite oxide having a crystalline structure belonging to Immm include a composite oxide represented by Liₓ₁M¹A¹₂. 1.5≤x1≤2.3 is satisfied. The M¹ includes at least one selected from the group consisting of Ni, Co, Mn, Cu, and Fe. A¹ contains at least oxygen. A¹ has a ratio of oxygen of 85 atomic % or more. A specific example is Li₂NiO₂. Examples of the lithium composite oxide having a crystalline structure belonging to Immm include a composite oxide represented by Liₓ₁M^{1A}₁₋ₓ₂M^{1B}ₓ₂O_{2-y}A²_{y}, 0≤x2≤0.5, 0≤y≤0.3. At least one of x2 and y is not zero. M^{1A} represents at least one selected from the group consisting of Ni, Co, Mn, Cu, and Fe. M^{1B} represents at least one selected from the group consisting of Al, Mg, Sc, Ti, Cr, V, Zn, Ga, Zr, Mo, Nb, Ta, and W. A2 represents at least one selected from the group consisting of F, Cl, Br, S, and P.

Examples of the lithium composite oxide having a crystalline structure belonging to P63-mmc include a composite oxide represented by M1ₓM2_{y}O₂. M1 represents an alkali-metal, preferably at least one of Na and K. M2 represents a transition-metal (preferably at least one selected from the group consisting of Mn, Ni, Co, and Fe), x+y satisfies 0<x+y≤2.

Examples of the lithium-containing composite oxide having a O2 type structure include a composite oxide represented by Liₓ[Li_{α}(MnₐCo_{b}M_{c})_{1-α}]O₂. 0.5<x<1.1, 0.1<α<0.33, 0.17<a<0.93, 0.03<b<0.50, 0.04<c<0.33. M represents at least one selected from the group consisting of Ni, Mg, Ti, Fe, Sn, Zr, Nb, Mo, W, and Bi. Specific examples include Li_{0.744}[Li_{0.145}Mn_{0.625}Co_{0.115}Ni_{0.115}]O₂ and the like.

The positive electrode preferably includes, in addition to the positive electrode active material, a solid electrolyte selected from the group consisting of a sulfide solid electrolyte, an oxide solid electrolyte, and a halide solid electrolyte. More preferably, at least a part of the surface of the positive electrode active material is coated with a sulfide solid electrolyte, an oxide solid electrolyte, or a halide solid electrolyte. As the halide solid electrolyte covering at least a part of the surface of the positive electrode active material, Li_{6-(4-x)b}(Ti₁₋ₓAlₓ)_{b}F₆ (0<x<1, 0<b≤1.5) [LTAF electrolyte] is preferred.

Examples of the conductive material include carbon material. The electrolyte may be a solid electrolyte or a liquid electrolyte. The solid electrolyte may be an organic solid electrolyte such as a gel electrolyte, or an inorganic solid electrolyte such as an oxide solid electrolyte or a sulfide solid electrolyte. In addition, the liquid electrolyte contains, for example, a support salt such as LiPF₆ and a solvent such as a carbonate-based solvent. Examples of the binder include a rubber-based binder and a fluoride-based binder.

The negative electrode active material layer contains at least a negative electrode active material. The negative electrode active material layer may further contain at least one of a conductive material, an electrolyte and a binder. Examples of the negative electrode active material include metal active material such as Li and Si, carbon active material such as graphite, and oxide active material such as Li₄Ti₅O₁₂. The shape of the negative electrode current collector is, for example, a foil shape or a mesh shape. The conductive material, the electrolyte and the binder are similar to those described above.

The electrolyte layer is disposed between the positive electrode active material layer and the negative electrode active material layer, and contains at least an electrolyte. The electrolyte may be a solid electrolyte or a liquid electrolyte. The electrolyte layer is preferably a solid electrolyte layer. The electrolyte layer may have a separator.

The solid electrolyte preferably includes at least one solid electrolyte species selected from the group consisting of a sulfide solid electrolyte, an oxide solid electrolyte, and a halide solid electrolyte.

The positive electrode current collector collects current from the positive electrode active material layer. Examples of the positive electrode current collector include stainless steel, aluminum, nickel, iron, titanium, and carbon, and an aluminum alloy foil or an aluminum foil is preferable. The aluminum alloy foil and the aluminum foil may be manufactured using powder. The shape of the positive electrode current collector is, for example, a foil shape or a mesh shape.

The negative electrode current collector collects current from the negative electrode active material layer. Examples of the material of the negative electrode current collector include metals such as copper, SUS, and nickel. Examples of the shape of the negative electrode current collector include a foil shape and a mesh shape.

### Battery

The laminated battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Also, the battery in the present disclosure may be used as a power source for mobile bodies other than vehicles (for example, railroads, ships, and aircraft), and may be used as a power source for electric products such as an information processing device.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

What is claimed is:

1. A laminated battery comprising:
an electrode body; and
laminate films that cover and seal the electrode body, wherein:
the laminate films each have a structure including at least a metal layer and a fusion resin layer stacked on an inner side of the metal layer;
the laminate films include a fused portion in which respective end portions of the laminate films are superposed to fuse the fusion resin layers on inner surfaces of the laminate films; and
a metal adhesion portion in which the metal layers closely contact each other over the entire fused portion in a longitudinal direction of the fused portion is provided in a part of the fused portion.

2. The laminated battery according to claim 1, wherein the fused portion includes a bent portion bent in an angular shape or an arcuate shape, and the metal adhesion portion is disposed in a region other than the bent portion.

3. The laminated battery according to claim 1, wherein the fused portion includes a plurality of metal adhesion portions.

4. A method of manufacturing a laminated battery including an electrode body and laminate films that cover and seal the electrode body, the laminate films each having a structure including at least a metal layer and a fusion resin layer stacked on an inner side of the metal layer, and the laminate films including a fused portion in which respective end portions of the laminate films are superposed to fuse the fusion resin layers on inner surfaces of the laminate films, the method comprising pressing the fused portion by sandwiching the fused portion from both sides using a pressing member and an opposing member, and forming a metal adhesion portion in which the metal layers closely contact each other over the entire fused portion in a longitudinal direction of the fused portion, wherein in the pressing, at least one of the pressing member and the opposing member is heated to a temperature equal to or higher than a glass transition temperature of the fusion resin layer.

5. The method according to claim 4, wherein:
a tip of the pressing member to contact the fused portion has a curved shape with a radius of curvature R of 0.2 mm or more and 1.68 mm or less; and
a tip of the opposing member to contact the fused portion has a smooth flat shape.
